(19) United States
(12) Patent Application Publication
(10) Pub. No.: US 2007/0175523 A1
(43) Pub. Date: Aug. 2, 2007

(54) Pressure relief assembly

(76) Inventors: Kenneth R. Levey, West Chicago, IL (US); Eric G. Parker, Winnetka, IL (US); Thomas S. King, Evanston, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/595,586

(22) Filed: Nov. 9, 2006

Related U.S. Application Data
(60) Provisional application No. 60/763,597, filed on Jan. 31, 2006.

(51) Int. Cl. F16K 15/14

(52) U.S. Cl. 137/512.15

(57) ABSTRACT

Embodiments of the present invention provide a pressure relief assembly that may include an inner shell having at least one air passage, and at least one membrane flap sealingly covering the air passage. The membrane flap is configured to move to open the air passage based on an air pressure level. The assembly may also include an outer shell secured to the inner shell, wherein an air channel is defined between the inner shell and the outer shell. The outer shell is configured to protect said inner shell from moisture. The assembly may also include at least one moisture catching ledge surrounding the air passage. The moisture catching ledge is configured to trap moisture that passes by the membrane flap.

### RELATED APPLICATIONS

This application relates to and claims priority benefits from U.S. Provisional Patent Application No. 60/763,597 entitled “Pressure Relief Device,” filed Jan. 31, 2006, which is hereby incorporated by reference in its entirety.

### FIELD OF THE INVENTION

Embodiments of the present invention generally relate to a venting or pressure relief device configured for use in an enclosed area, such as an automobile, and more particularly to a pressure relief device that protects against debris and moisture infiltration.

### BACKGROUND OF THE INVENTION

Interior cabins of vehicles typically include cabin vents or pressure relief devices. Without such devices, air pressure inside the vehicle cabin could damage the occupants' ear drums. Further, when a vehicle door is closed, air pressure within the vehicle needs to be relieved or the door will not close. If an air bag is activated in a vehicle that does not have a venting or pressure relief device, an occupant's ear drums may be damaged.

Pressure relief devices are usually hidden from view. For example, a pressure relief device may be found in a trunk or on a body frame pillar structure. Each pressure relief device is adapted to allow air to pass out of an enclosed structure, while also preventing a significant amount of air, dust, water or other contaminants into the enclosed area. Thus, pressure relief devices are, in essence, one-way valves or one-way check valves, and are configured to maintain a small amount of back pressure per customer specifications.

FIG. 1 illustrates an isometric view of a conventional pressure relief device 10. The pressure relief device 10 includes a plastic main body 12 having a plurality of air passages 14. A light membrane 16 is positioned over the air passages 14, and is configured to allow air to pass in one direction. In order to allow air to pass, the light membrane 16 opens off of the main body 12 in response to air flow. Typically, a seal (not shown) is provided around the main body 12 and acts to seal the hole in the mating structure (not shown) upon assembly. The seal is typically molded around the main body 12 in a secondary molding operation, or may be adhesively or chemically attached to the main body 12.

During installation, the pressure relief device 10 may be snap fit to a structure. Typically, a user presses on the four corners of the pressure relief device 10 in order to secure it within a reciprocal hole in a structure.

If liquid contacts or accumulates on the pressure relief device 10, the liquid passes to a drain hole or channel. Gravity and the vertical orientation of the pressure relief device 10 assist in draining or channeling the liquid from the pressure relief device 10.

In large vehicles, such as semi-trucks, conventional pressure relief devices are known to allow the intrusion of water or other liquids into the enclosed area due to the size of the device, and the amount of water present. For example, during a high pressure cleaning process, a substantial amount of water may accumulate on, and infiltrate past, the pressure relief device.

Thus, a need exists for a pressure relief device that provides greater protection against moisture infiltration.

### SUMMARY OF THE INVENTION

Certain embodiments of the present invention provide a pressure relief assembly that includes an inner shell having at least one air passage, and at least one membrane flap sealingly covering the air passage(s). The membrane flap(s) are configured to move to open the air passage(s) based on an air pressure level.

The pressure relief assembly may also include an outer shell secured to the inner shell, wherein an air channel is defined between the inner shell and the outer shell. The outer shell is configured to protect the inner shell from foreign materials, substances, or elements, such as water, dirt, dust, debris, and the like.

The pressure relief assembly may also include at least one moisture catching ledge surrounding the air passage(s). The moisture catching ledge(s) are configured to trap moisture that passes by the membrane flap(s). Trapped moisture may be blown clear with air flow from closing doors or an HVAC system.

Certain embodiments of the present invention also provide a pressure relief assembly configured to be secured to a panel within an automobile. The pressure relief assembly may include an inner shell having air passages, membrane flaps sealingly covering the air passages, moisture catching ledges surrounding each of the air passages, and an outer shell secured to the inner shell. The moisture catching ledges are configured to trap moisture that passes by the membrane flaps.

An air channel is defined between the inner shell and the outer shell. The outer shell is configured to protect the inner shell from foreign materials. The outer shell may include at least one push button configured to be engaged to secure the outer shell to the inner shell, and at least one air outlet configured to allow air within the air channel to pass out of the pressure relief assembly.

The inner shell may include a ridge and a sealing lip that cooperate to snapably and sealingly secure the inner shell within an aperture of a panel. The inner shell may also include an angled base, wherein the membrane flaps conform to at least a portion of the angled base. For example, two membrane flaps may be integrally connected to one another, and the angled base bends the two membrane flaps toward one another. Consequently, the two membrane flaps exert a resistive force into the angled base, thereby keeping the air passages closed, and providing a small amount of back pressure.

The inner shell may also include at least one push button operatively connected to a latch member, such as a ramp, clasp, barb, or other such protuberance configured to secure the inner shell to a structure.

### BRIEF DESCRIPTION OF SEVERAL VIEWS OF THE DRAWINGS

FIG. 1 illustrates an isometric view of a conventional pressure relief device.

FIG. 2 illustrates an isometric view of a pressure relief assembly according to an embodiment of the present invention.

FIG. 3 illustrates an isometric view of a pressure relief assembly according to an embodiment of the present invention.

FIG. 4 illustrates a cross-sectional view of a pressure relief assembly according to an embodiment of the present invention.

FIG. 5 illustrates a top plan view of a pressure relief assembly according to an embodiment of the present invention.

FIG. 6 illustrates a cross-sectional view of a pressure relief assembly through line 6-6 of FIG. 5 according to an embodiment of the present invention.

FIG. 7 illustrates a cross-sectional close up view of a pressure relief assembly secured to a structure according to an embodiment of the present invention.

FIG. 8 illustrates a flexible sheet secured to an inner shell of a pressure relief assembly according to an embodiment of the present invention.

FIG. 9 illustrates a simplified view of a flexible sheet being secured to an inner shell of a pressure relief assembly according to an embodiment of the present invention.

FIG. 10 illustrates an isometric cross-sectional view of an inner shell of a pressure relief assembly according to an embodiment of the present invention.

FIG. 11 illustrates a partial isometric view of a push button positioned on an inner shell of a pressure relief assembly according to an embodiment of the present invention.

FIG. 12 illustrates a cross-sectional view of an inner shell along line 12-12 of FIG. 11 according to an embodiment of the present invention.

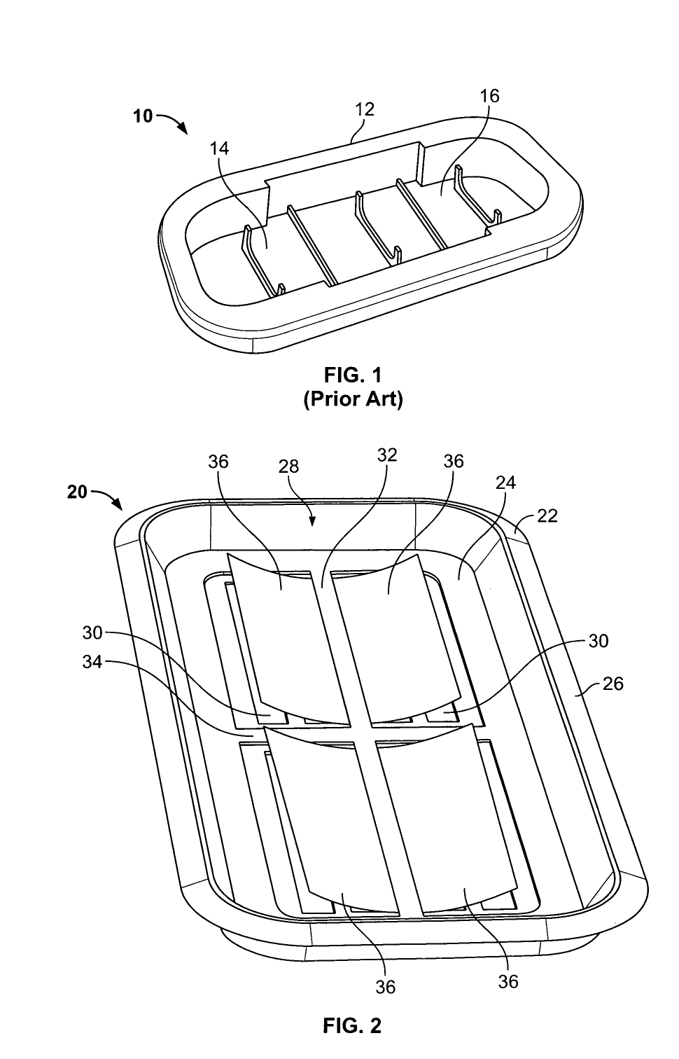

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

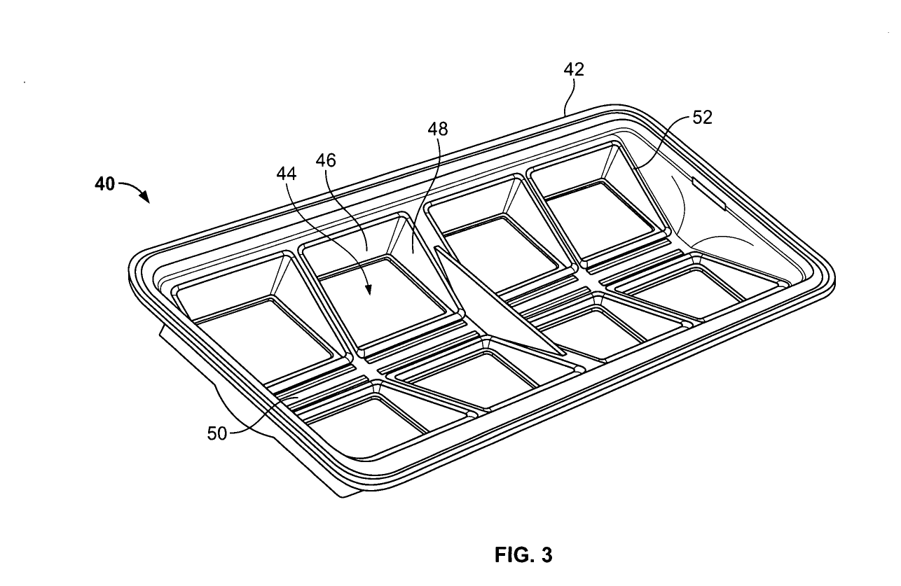

FIG. 2 illustrates an isometric view of a pressure relief assembly 20 according to an embodiment of the present invention. The pressure relief assembly 20 includes an inner shell 22 having a base 24 surrounded by a flange 26 that extends upwardly from the base 24. An interior cavity 28 is defined between the base 24 and the flange 26.

The inner shell 22 may be formed of a plastic, such as acrylic, or a thermoplastic, such as ABS, or any other suitable plastic material. The inner shell 22 may be thermoformed, which is generally an efficient and economical way of making various plastic devices. During the manufacturing process, a roll of plastic is fed into a cavity, and then the plastic is formed using heat and pressure.

A plurality of air passages 30 are formed through the base 24. The air passages 30 may be single openings, or a series of openings. The air passages 30 may be angled with respect to the base, or coplanar with the base 24. Adjacent air passages 30 are separated by a coupling beam 32 or a cross beam 34. As shown in FIG. 2, the coupling beam 32 horizontally separates two air passages 30 within a row from one another, while the cross beam 34 vertically separates two air passages 30 in a column from one another.

A resilient, flexible membrane flap 36 covers each air passage 30. Each flexible membrane flap 36 may be formed of a flexible plastic, such as Lexan or Mylar. One end of the flexible membrane flap 36 is secured to the coupling beam 32. The membrane flap 36 may be sandwiched between two acrylic sheets that form the inner shell 22. The membrane flap 36 is configured to resist air pressure up to a certain point. That is, the membrane flap 36 may be configured to remain fully seated until a certain amount of air pressure is exerted into the membrane flap. Thus, when air is released through the air passages 30, the flexible membrane flaps 36 are forced upward as shown in FIG. 2 in order to allow the air to pass. After the air has passed, thereby relieving air pressure, the flexible membrane flaps 36 flex, snap or spring back over the air passages 30 in order to prevent moisture or other debris from passing into the air passages 30.

Adjacent flexible membrane flaps 36 may be integrally formed as a single sheet of material. For example, the top row of flexible membrane flaps 36 may be a single sheet of Lexan passed under, and secured to, the coupling beam 32, at a mid-section. As such, each row of flexible membrane flaps 36 may be integrally coupled to one another.

The flexible membrane flaps 36 may be part of a single flexible sheet secured to an inner shell about a central beam (as discussed below). Optionally, the membranes may each be a layer of Lexan compressively sandwiched between two acrylic layers that form a base of the inner shell. Additionally, the membranes may be cut from a single layer of Lexan and securely overlayed on the inner shell 22 over the air passages.

While FIG. 2 shows four air passages 30, the pressure relief assembly 20 may include more or less air passages 30 than those shown. Additionally, the air passages 30 may or may not be coplanar with the base 24.

For example, FIG. 3 illustrates an isometric view of a pressure relief assembly 40 according to an embodiment of the present invention. The pressure relief assembly 40 includes an inner shell 42 having eight air passages 44. The air passages 44 are defined by outer walls 46 integrally connected to interior walls 48 that angle down and integrally connect to a coupling rib 50. Flexible membranes 52 are positioned over the air passages 44, as discussed above.

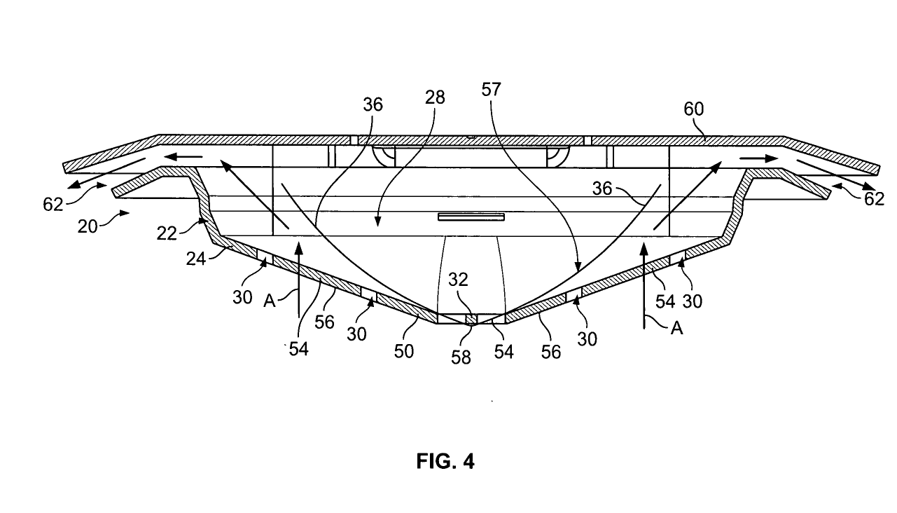

FIG. 4 illustrates a cross-sectional view of the pressure relief assembly 20 according to an embodiment of the present invention. As shown in FIG. 4, each air passage 30 may include a plurality of separate openings 54 separated by panels or ribs 56. Additionally, the flexible membrane flaps 36 may be part of a single, flexible, resilient sheet 57 having its mid-section 58 secured underneath the coupling beam 32.

The pressure relief assembly 20 may also include an outer shell, or umbrella, 60 secured over the inner shell 22. The outer shell 60 eliminates the outer seal member used in prior pressure relief devices. An air channel 62 is defined between the outer shell 60 and the inner shell 22. The outer shell 60 also includes openings (not shown in FIG. 4) that allow air to pass.

In operation, when air pressure becomes too great within a structure, air is forced through the air passages 30 of the inner shell 22 in the direction of arrows A. The pressure exerted by the air on the flexible membrane flaps 36 forces the flexible membrane flap 36 upward about the coupling beam 32. Thus, the air passages 30 are opened, and air passes into the interior cavity 28 of the inner shell 22. The air within the interior cavity 28 then passes through the air channel 62 and out of the pressure relief assembly 20 through openings formed in the outer shell 60.

After the pressure has been relieved, the flexible membrane flaps 36 flex back over the air passages 30, thereby sealing the air passages from moisture infiltration. As such, the flexible membrane flaps 36 protect against moisture, particles or debris from passing from the interior cavity 28 into the air passages 30. The outer shell 60 also acts to prevent moisture, particles or debris from passing from the outside into the interior cavity 28. Thus, in order for moisture or other particles to enter into a structure, the foreign material (such as external moisture, dirt, debris, or the like) would first have to penetrate the outer shell 60. Then, the foreign material would have to navigate through the air channel 62 toward the inner shell 22. If the foreign material made it to this point, it would still have to slip past the membrane flaps 36.

Alternatively, the pressure relief assembly 20 may not include the outer shell 60. Instead, the inner shell 22 may adequately prevent moisture, particles or debris from passing into the air passages 30.

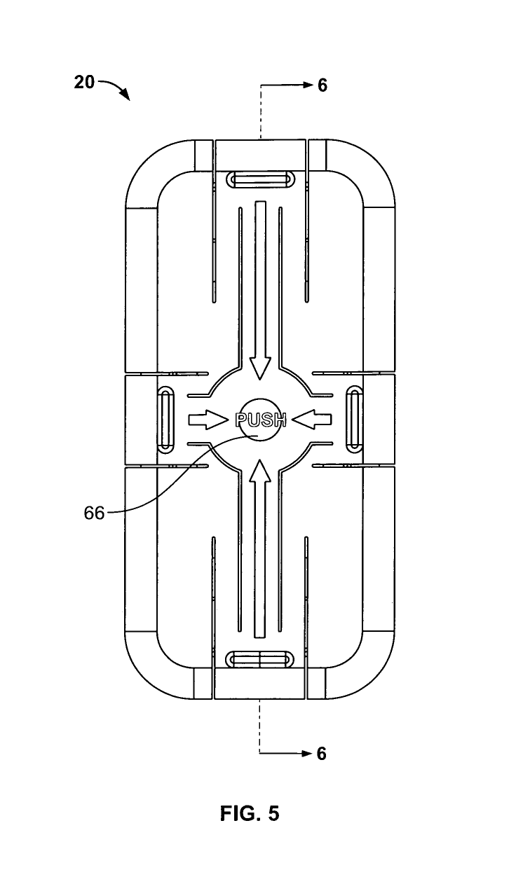

FIG. 5 illustrates a top plan view of the pressure relief assembly 20. The outer shell 60 is secured over the inner shell 22 (hidden from view in FIG. 5). The outer shell 60 includes a plurality of openings that allow air within the interior cavity 28 (not shown in FIG. 5) of the inner shell 22 to pass out of the pressure relief assembly 20. Additionally, a push button 66 is located at the center of the outer shell 60. The push button 66 is configured to be engaged by a user and snapably secure the outer shell 60 over the inner shell 22. The push button 66 may be positioned so that it is not aligned over any membrane flap 36. Thus, when a user engages the push button 66, the user does not risk puncturing or otherwise damaging any of the membrane flaps 36.

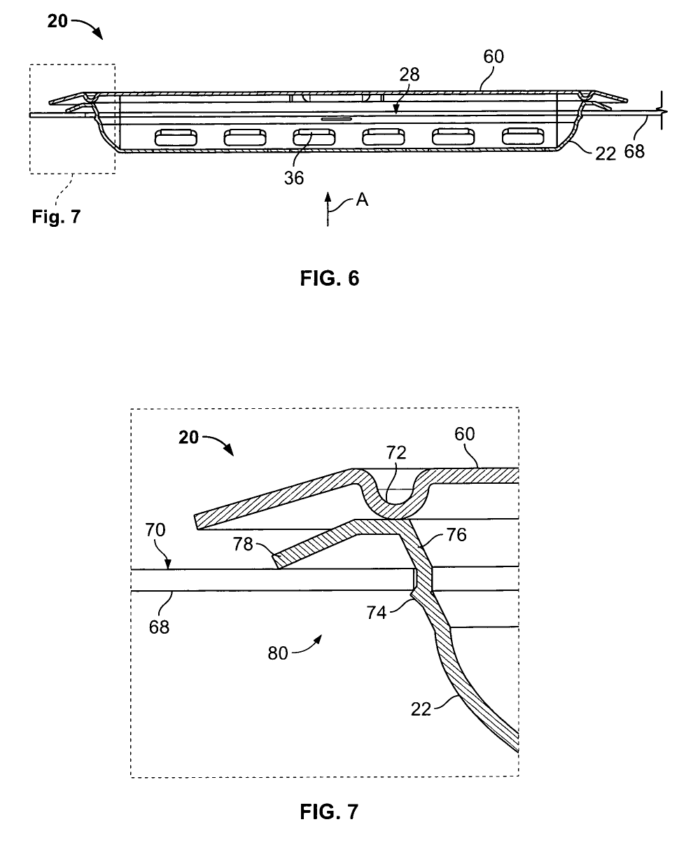

FIG. 6 illustrates a cross-sectional view of the pressure relief assembly 20 through line 6-6 of FIG. 5. The outer shell 60 is secured over the inner shell 22. Further, the inner shell 22 is snapably secured within a hole formed through a metal panel 68 such as found within a vehicle. As discussed above, air may be forced from within a structure defined by the metal panel 68 toward the inner shell 22 in the direction of arrow A. The air forces the flexible membrane flaps 36 open (i.e., the air unseats the flexible membrane flaps 36), so that the air passes into the interior cavity 28. The air may then pass through air channels and openings in order to pass out of the pressure relief assembly 20. After the air pressure is relieved, the flexible membrane flaps 36 re-seat over the air passages 30.

FIG. 7 illustrates a cross-sectional close up view of the pressure relief assembly 20 secured to a structure 70 defined by the metal panel 68. The outer shell 60 may be secured to the inner shell 22 through a series of welds 72. Alternatively, the outer shell 60 may snapably secure to the inner shell 22, or may secure to the inner shell 22 through an interference fit, bolts, screws, or various other fasteners.

The inner shell 22 also includes a ridge 74 proximate an upper end 76. A lip 78 is integrally connected to the ridge 74. The ridge 74 and the lip 78 act to snapably secure, or compressively sandwich, the metal panel 68 therebetween, thereby securing the pressure relief assembly 20 within an opening defined by the metal panel 68. A distal edge of the lip 78 sealingly engages the metal sheet 68, thereby preventing moisture from passing into the interior chamber 80 of the structure 70.

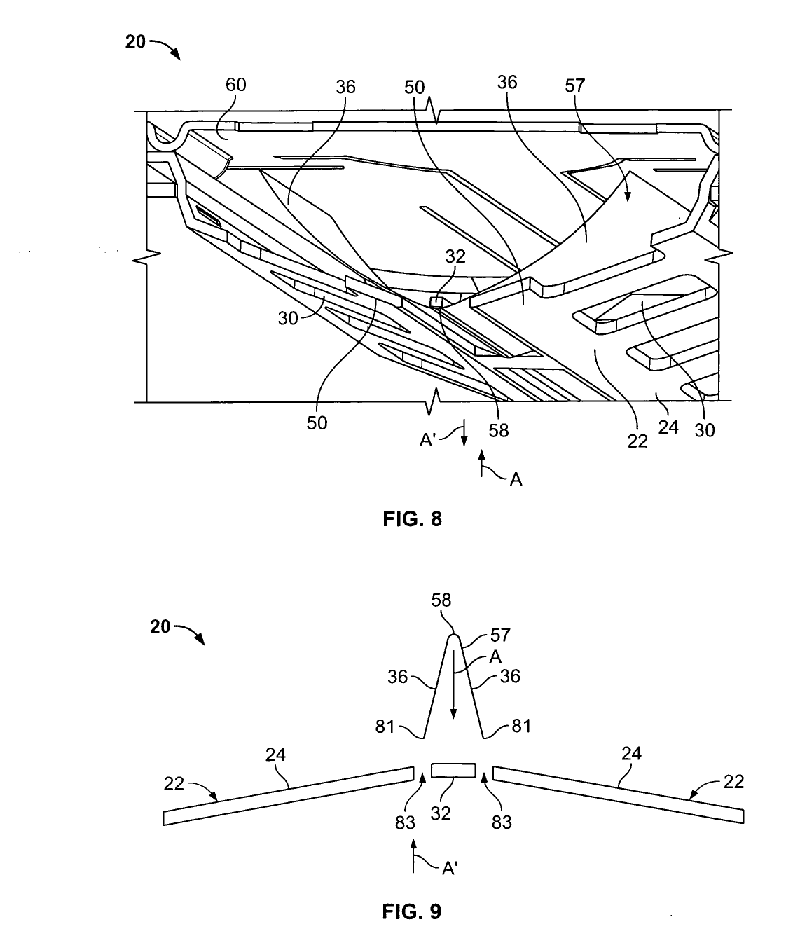

FIG. 8 illustrates a flexible sheet 57 secured to an inner shell 22 of a pressure relief assembly 20 according to an embodiment of the present invention. The flexible sheet 57 may be installed without heat to eliminate potential warping. The flexible sheet 57 is secured to the coupling beam 32 of the inner shell 22, thereby forming two flexible membrane flaps 36. The flexible sheet 57 is a single piece of material, such as Lexan, with the ends forming a membrane flap 36. Each membrane flap 36 is configured to sealingly cover an air passage 30. The flexible sheet 57 is resilient and is configured to tend to snap back to a flat position when forces are no longer exerted into the sheet 57. The coupling beam 32 exerts a force into the mid section 58 of the flexible sheet 57 in the direction of arrow A′. Meanwhile, ribs 50 and other structure defining the air passages 30 exert a force into the other side of the flexible sheet 57 proximate the membrane flaps 36 in the direction of arrow A. The opposing forces bend the flexible sheet 57 and secure it in place. Because the flexible sheet 57 continually attempts to flatten out, the flattening forces exerted by the sheet 57 into the inner shell 22 ensure that the membrane flaps 36 sealingly engage the inner shell 22 over adjacent air passages 30.

As shown in FIG. 8, the base 24 of the inner shell 22 is angled. That is, the base 24 angles toward the outer shell 60 from the coupling beam 32. The angled nature of the base 24, and the forces exerted into and by the flexible sheet 57 discussed above provide a spring force that ensures that the membrane flaps 36 remain seated over the air passages 30, as shown, for example, in FIGS. 2 and 4 (until air pressure unseats the membrane flaps 36).

FIG. 9 illustrates a simplified view of a flexible sheet 57 being secured to an inner shell 22 of a pressure relief assembly 20. Ends 81 of the flexible sheet 57 are squeezed toward one another so that the ends may pass through the openings 83. In this position, the flexible sheet 57 is urged toward the inner shell 22 in the direction of arrow A so that the ends 81 pass through the openings 83. Once the mid section 58 is positioned against the coupling beam 32, the ends 81 are released, thereby spreading open as the flexible sheet 57 attempts to flatten out. Thus, the membrane flaps 36 flex into position over the air passages 30 (shown, for example, in FIG. 8). The flexible sheet 58 is held in place by exerting a force into the coupling beam 32, which exerts an equal but opposite force into the mid-section in the direction of arrow A′. Simultaneously, the force exerted by the base 24 into the ends 81 of the membrane flaps 36 is resisted by the resilient, flexible sheet 57, thereby providing a sealing engagement over the air passages 30. Because the sheet 57 is bent, it will naturally tend to return to a flat shape, thereby exerting a sealing force into the inner shell 22. Thus, the air passages 30 remain closed unless air or other pressure is exerted into the membrane flaps 36 from within a structure.

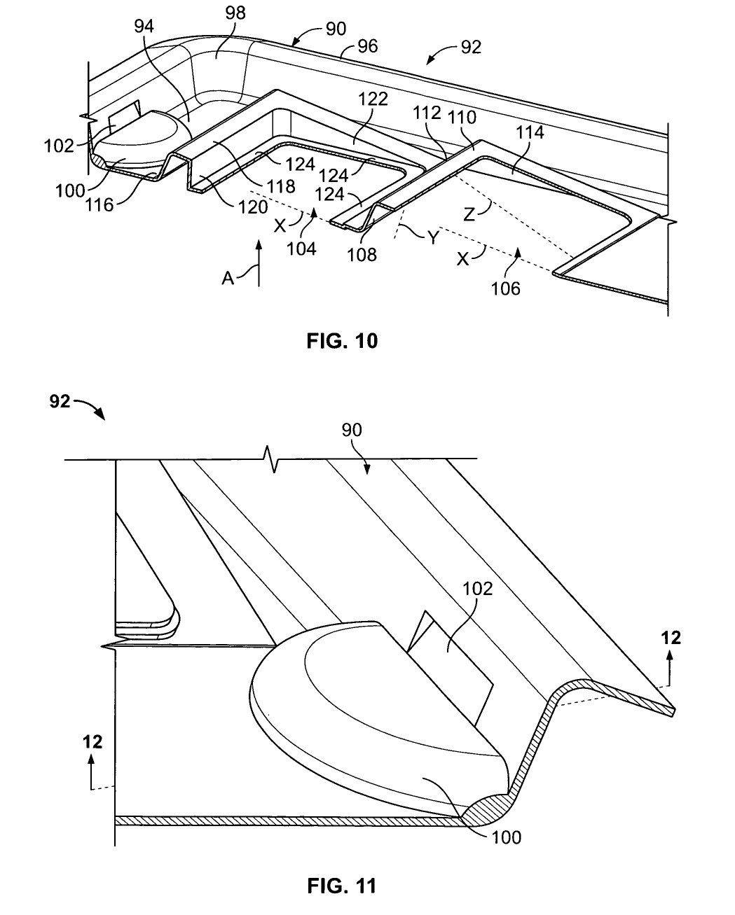

FIG. 10 illustrates an isometric cross-sectional view of an inner shell 90 of a pressure relief assembly 92 according to an embodiment of the present invention. The inner shell 90 includes a base 94 surrounded by integrally formed walls 96 with an interior cavity 98 defined between the base 94 and the walls 96. Push buttons 100 operatively connected to latch members, such as snap ramps 102, clasps, bars, or the like, are located at ends of the base 94 proximate a union of the base 94 and the wall 96.

Air passages 104 and 106 are formed through the base 94. The air passage 106 is defined by a wall 108 upwardly extending from the base 94. The wall 108 includes a lip 110 extending over the air passage 106 from an upper edge 112 of the wall 108. The wall 108 is integrally connected to lateral walls 114 that angle down toward the base 94. The lip 110 integrally extends over upper edges of the lateral walls 114. A flexible membrane is positioned over the air passage 106, as discussed above.

When the inner shell 90 is formed during a molding process, a plurality of cuts are used to form the air passage 106. In order to form the air passage 106, a tool may separately cut through planes x, y, and z.

The air passage 104 is defined by a wall 116 integrally formed with lateral walls (not shown) that extend to the base 94. The wall 116 and the lateral walls are integrally connected to an upper ledge 118. The upper ledge 118, in turn, is integrally formed with a wall 120 and lateral walls 122 that extend down to the plane of the base 94. Lower ledges 124, which are coplanar with the base 94, are integrally connected to lower edges of the wall 120 and the lateral walls 122. The air passage 104, which is coplanar with the base 94, is defined between the lower ledges 124. Because the air passage 104 is oriented on a single plane X, a tool only needs to cut along or through the plane X in order to form the air passage 104, thereby minimizing trimming costs.

The lower ledges 124 form a safety catch or barrier that is configured to trap excess moisture. That is, when the membranes are unseated, small amounts of moisture may pass into the air passage 104. That moisture settles onto the ledges 124. When air is forced through the air passage 104 in the direction of arrow A, the air blows the moisture away from the air passage 104. The lower ledges 124 catch stray water droplets that bypass the membranes. The stray water is blown out, for example, when vehicle doors are closed, or an HVAC system is used. Thus, a moisture catching ledge or barrier surrounds the air passage 104.

The inner shell 90 may include any number of air passages 104 and 106. Moreover, the inner shell 90 may include only air passages 104 or air passages 106.

FIG. 11 illustrates a partial isometric view of the push button 100 positioned on the inner shell 90 of a pressure relief assembly 92. The push button 100 is operatively connected to the snap ramp 102. In order to secure the inner shell 90 to a structure, the inner shell 90 is positioned over an opening formed in a panel such that the snap ramps 102 are aligned with reciprocal mating structures.

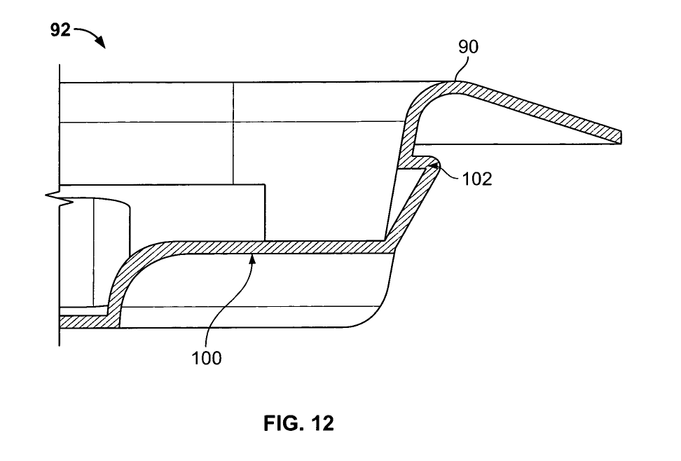

FIG. 12 illustrates a cross-sectional view of the inner shell 90 along line 12-12 of FIG. 11. During installation, a user pushes the push button 100, which provides a tactile feel that lets the user know that the push button 100 is properly engaged. Because the push button 100 is integrally connected to the snap ramp 102, the snap ramp 102 moves inwardly as the push button 100 is pushed down. As a user disengages the push button 100, the snap ramp 102 snaps back out into a securing position. During this movement, the snap ramp 102 may emit an audible snap as it snapably secures to a mating structure. Because the snap ramp 102 is pulled inwardly when the push button 100 is pushed, installation effort is decreased because less of the snap ramp 102 abuts against an edge of a panel during an insertion process. When the push button 100 is released, the snap ramp 102 snaps back into position, thereby providing a robust and secure connection. Thus, the push button 100 and snap ramp 102 allow the inner shell 90 to be easily and securely connected to a structure, such as a metal panel.

Thus, embodiments of the present invention provide a pressure relief device that provides greater protection against moisture infiltration. Certain embodiments of the present invention provide a pressure relief assembly that includes moisture barriers surrounding air passages, with sealing membranes positioned over the air passages. Certain embodiments of the present invention also provide an outer shell positioned over the inner shell. The outer shell prevents moisture from contacting the inner shell.

While various spatial terms, such as upper, lower, mid, lateral, horizontal, vertical, and the like may used to describe portions of the described embodiments, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A pressure relief assembly comprising:
an inner shell having at least one air passage;
at least one membrane flap sealingly covering said at least one air passage, said at least one membrane flap configured to move to open said at least one air passage based on an air pressure level; and
an outer shell secured to said inner shell, wherein an air channel is defined between said inner shell and said outer shell, said outer shell configured to protect said inner shell from moisture.

2. The pressure relief assembly of claim 1, wherein said outer shell comprises at least one push button configured to be engaged to secure said outer shell to said inner shell.

3. The pressure relief assembly of claim 1, wherein said outer shell comprises at least one air outlet.

4. The pressure relief assembly of claim 1, wherein said inner shell comprises a ridge and a sealing lip, wherein said ridge and said sealing lip cooperate to snapably and sealingly secure said inner shell within an aperture of a metal panel.

5. The pressure relief assembly of claim 1, wherein said inner shell comprises an angled base, said at least one membrane flap conforming to at least a portion of said angled base.

6. The pressure relief assembly of claim 5, wherein said at least one membrane flap comprises two membrane flaps integrally connected to one another, said angled base bending said two membrane flaps toward one another, and said two membrane flaps exerting a resistive force into said angled base.

7. The pressure relief assembly of claim 1, wherein said inner shell is formed of acrylic, and said at least one membrane flap is formed of one of Lexan and Mylar.

8. The pressure relief assembly of claim 1, further comprising at least one moisture catching ledge surround said at least one air passage.

9. The pressure relief assembly of claim 1, wherein said inner shell comprises at least one push button operatively connected to a latch member configured to secure said inner shell to a structure.

10. A pressure relief assembly comprising:
an inner shell having at least one air passage;
at least one membrane flap sealingly covering said at least one air passage, said at least one membrane flap configured to move to open said at least one air passage based on an air pressure level; and
at least one moisture catching ledge surrounding said at least one air passage, said at least one moisture catching ledge configured to trap moisture that passes by said at least one membrane flap.

11. The pressure relief assembly of claim 10, wherein said inner shell comprises an outwardly extending ridge and a sealing lip, wherein said ridge and said sealing lip cooperate to snapably and sealingly secure said inner shell within an aperture of a metal panel.

12. The pressure relief assembly of claim 10, wherein said inner shell comprises an angled base, said at least one membrane flap conforming to at least a portion of said angled base.

13. The pressure relief assembly of claim 12, wherein said at least one membrane flap comprises two membrane flaps integrally connected to one another, said angled base bending said two membrane flaps toward one another, and said two membrane flaps exerting a resistive force into said angled base.

14. The pressure relief assembly of claim 10, wherein said inner shell comprises at least one push button operatively connected to a latch member configured to secure said inner shell to a structure.

15. A pressure relief assembly configured to be secured to a panel within an automobile, the pressure relief assembly comprising:
an inner shell having air passages;
membrane flaps sealingly covering said air passages, said membrane flaps configured to move to open said air passages based on an air pressure level;
moisture catching ledges surrounding each of said air passages, said moisture catching ledges configured to trap moisture that passes by said membrane flaps; and
an outer shell secured to said inner shell, wherein an air channel is defined between said inner shell and said outer shell, said outer shell configured to protect said inner shell from foreign materials, said outer shell comprising (i) at least one push button configured to be engaged to secure said outer shell to said inner shell, and (ii) at least one air outlet configured to allow air within said air channel to pass out of the pressure relief assembly.

16. The pressure relief assembly of claim 15, wherein said inner shell comprises a ridge and a sealing lip, wherein said ridge and said sealing lip cooperate to snapably and sealingly secure said inner shell within an aperture of a metal panel.

17. The pressure relief assembly of claim 15, wherein said inner shell comprises an angled base, said membrane flaps conforming to at least a portion of said angled base.

18. The pressure relief assembly of claim 17, wherein said membrane flaps comprise two membrane flaps integrally connected to one another, said angled base bending said two membrane flaps toward one another, and said two membrane flaps exerting a resistive force into said angled base.

19. The pressure relief assembly of claim 15, wherein said inner shell is formed of acrylic, and said at least one membrane flap is formed of one of Lexan and Mylar.

20. The pressure relief assembly of claim 15, wherein said inner shell comprises at least one push button operatively connected to a latch member configured to secure said inner shell to a structure.
